(19) United States
(12) Patent Application Publication
(10) Pub. No.: US 2024/0408827 A1
(43) Pub. Date: Dec. 12, 2024

(54) FIBER FUSE DETECTION IN ADDITIVE MANUFACTURING

(71) Applicant: VulcanForms Inc., Burlington, MA (US)

(72) Inventors: Peter Colin Reeves-Hall, Whitinsville, MA (US); Mark Christopher Mordarski, South Glastonbury, CT (US)

(73) Assignee: VulcanForms Inc., Burlington, MA (US)

(21) Appl. No.: 18/735,814

(22) Filed: Jun. 6, 2024

Related U.S. Application Data
(60) Provisional application No. 63/472,488, filed on Jun. 12, 2023.

(51) Int. Cl. B29C 64/393; B29C 64/153; B29C 64/268; B33Y 10/00; B33Y 30/00; B33Y 50/02

(52) U.S. Cl. CPC B29C 64/393; B29C 64/153; B29C 64/268; B33Y 10/00; B33Y 30/00; B33Y 50/02

(57) ABSTRACT

Systems and methods involved in additive manufacturing are disclosed. One or more optical fibers optically couple one or more laser energy sources and an optics assembly. One or more photosensitive detectors are arranged along a length of the one or more optical fibers between an output of the one or more laser energy sources and an input of the optics assembly. Each photosensitive detector among the one or more photosensitive detectors is in a contact-less arrangement with one or more of the two or more optical fibers. Each photosensitive detector among the one or more photosensitive detectors detects fiber fuse-generated propagation of plasma through the one or more optical fibers. The system also includes one or more processors arranged to receive signals from the one or more photosensitive detectors and to control operation of the one or more laser energy sources based at least in part on the signals.

### RELATED APPLICATION

This application claims priority under 35 U.S.C. § 119 (e) to U.S. Provisional Application No. 63/472,488, filed Jun. 12, 2023, the content of which is incorporated by reference in its entirety for all purposes.

### FIELD

Disclosed embodiments are generally related to fiber fuse detection in additive manufacturing.

### BACKGROUND

Additive manufacturing systems employ various techniques to create three-dimensional objects from two-dimensional layers. After a layer of precursor material is deposited onto a build surface, a portion of the layer may be fused through exposure to energy from one or more energy sources (e.g., lasers) to create a desired two-dimensional geometry of solidified material within the layer. The energy is conveyed from the one or more energy sources through optical fibers. Under certain conditions (e.g., defect in an energy source, dust on a lens used to direct the energy), a fiber fuse may be generated by the energy. Fiber fuse refers to a light-induced catastrophic destruction of the optical fiber conveying the energy. The effect is initiated by spot-heating of the optical fiber and results in the propagation of plasma from the location of the spot-heating back to the energy source. If this propagation of plasma is not interrupted along the path back to the energy source, it can damage not only the optical fiber along the path but also the energy source.

### SUMMARY

According to some aspects, an additive manufacturing system includes a build surface to support a precursor material, one or more laser energy sources, and an optics assembly to direct laser energy from the one or more laser energy sources toward the build surface to form a corresponding one or more laser pixels on the build surface to selectively fuse the precursor material on the build surface. The system also includes one or more optical fibers optically coupling the one or more laser energy sources and the optics assembly and one or more photosensitive detectors arranged along a length of the one or more optical fibers between an output of the one or more laser energy sources and an input of the optics assembly. Each photosensitive detector among the one or more photosensitive detectors is in a contact-less arrangement with one or more of the two or more optical fibers. Each photosensitive detector among the one or more photosensitive detectors detects fiber fuse-generated propagation of plasma through the one or more optical fibers. The system also includes one or more processors arranged to receive signals from the one or more photosensitive detectors and to control operation of the one or more laser energy sources based at least in part on the signals.

According to other aspects, an additive manufacturing method is provided. The method includes controlling transmission of laser energy from one or more laser energy sources through an optics assembly, via one or more optical fibers optically coupling the one or more laser energy sources and the optics assembly, toward a build surface to expose a layer of material on the build surface to the laser energy to melt at least a portion of the layer of material due to exposure of the portion to the laser energy. The method also includes obtaining signals from one or more photosensitive detectors in contact-less arrangement with the one or more of the one or more optical fibers along a length of the one or more optical fibers between an output of the one or more laser energy sources and an input of the optics assembly. The signals indicate a fiber fuse-generated propagation of plasma through the one or more optical fibers. The method additionally includes controlling operation of the one or more laser energy sources based at least in part on the signals.

According to still other aspects, a non-transitory computer-readable medium stores instructions that, when processed by one or more processors, cause the one or more processors to implement a method for additive manufacturing. The method includes controlling transmission of laser energy from one or more laser energy sources through an optics assembly, via one or more optical fibers optically coupling the one or more laser energy sources and the optics assembly, toward a build surface to expose a layer of material on the build surface to the laser energy to melt at least a portion of the layer of material due to exposure of the portion to the laser energy. The method also includes obtaining signals from one or more photosensitive detectors in contact-less arrangement with the one or more of the one or more optical fibers along a length of the one or more optical fibers between an output of the one or more laser energy sources and an input of the optics assembly. The signals indicate a fiber fuse-generated propagation of plasma through the one or more optical fibers. The method additionally includes controlling operation of the one or more laser energy sources based at least in part on the signals.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows the optical paths present in an additive manufacturing system according to some embodiments;

FIG. 3 shows an additive manufacturing system according to some embodiments;

FIG. 4 shows photosensitive detectors arranged in a one-to-one relationship with optical fibers according to some embodiments;

FIG. 5 shows photosensitive detectors within an optical fiber connector according to some embodiments;

FIG. 6 shows a printed circuit board hold photosensitive detectors according to some embodiments;

FIG. 7A shows a top view of opaque masks arranged relative to optical fibers according to some embodiments;

FIG. 7B shows a side view of the opaque masks in FIG. 7A along with a photosensitive detector;

FIG. 8 shows an arrangement of photosensitive detectors with diameters greater than a pitch of optical fibers according to some embodiments;

FIG. 9 shows an arrangement of photosensitive detectors including masks to limit field of view and optical fibers separated by baffles according to some embodiments; and

FIG. 10 is a process flow of a method for additive manufacturing including detecting fiber fuse according to some embodiments.

### DETAILED DESCRIPTION

Additive manufacturing systems generally build up a three-dimensional object, one layer at a time. Each successive layer bonds to a preceding layer of melted or partially melted material. The melting is accomplished by energy sources such as laser energy sources that convey light energy that is directed to the material via optical fibers. A phenomenon that can occur in an optical fiber is fiber fuse. Because of a defect in the laser energy source, debris on a focusing lens, an imperfection in the optical fiber, or the like, the energy being conveyed by the optical fiber may precipitate localized heating with temperatures approaching 1000 degrees Centigrade. This in turn causes thermal lensing in the core of the optical fiber forming a plasma of many thousands of degrees Celsius. The fiber fuse may be visible as a bright white light based on the plasma formed within the core of the optical fiber converting laser energy to broad spectrum black body radiation corresponding to the high temperatures of the plasma.

Once fiber fuse is initiated in an optical fiber, the plasma formed by the localized heating can travel toward the laser energy source (i.e., in an opposite direction of the energy transmission), leaving cavities in the optical fiber along its path. The plasma propagation may be at a velocity of several meters per second (e.g., 1 to 5 meters per second). If the plasma reaches the laser energy source, it may damage the laser energy source in addition to the portion of the optical fiber it has traversed. In addition, the fiber fuse may cause mechanical instability in the acrylate (or other) coatings of the fiber, potting compounds, or epoxy holding the fiber, potentially causing mechanical issues in neighboring optical fibers, making those optical fibers more susceptible to subsequent fiber fuse. In addition, fiber fuses may cause generation of particulates due to heating/combustion of potting compounds or fiber coatings that can settle on nearby fibers and be strong absorbers of laser light, causing localized heating and making those optical fibers more susceptible to subsequent fiber fuse.

In view of the above, the inventors have recognized and appreciated the benefits of detecting fiber fuse-generated propagation of plasma directly from an optical fiber anywhere along its length between a laser energy source and the optics assembly that directs the energy from the laser energy source onto a build surface formed by a layer of precursor material disposed on a corresponding build plate. By detecting fiber fuse prior to it propagating into the laser energy source, the relevant laser energy source may be turned off to prevent further damage. Laser energy sources adjacent to the affected optical fiber may also be optionally turned off in some embodiments to mitigate against the fiber fuse creating a cascading set of failures in neighboring optical fibers due to contamination and/or direct damage from the fiber fuse event. By using photosensitive detectors that are sensitive only to wavelengths of light shorter or longer than that of the laser sources, the fiber fuse detection according to the embodiments may be protected from false alarms based on the presence of laser light.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 KW). For example, the power output for each laser energy source may be between about 100 W and about 1.5 kW, and/or between about 500 W and about 1 kW. Moreover, a total power output of the plurality of laser energy sources may be between about 500 W (0.5 kW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

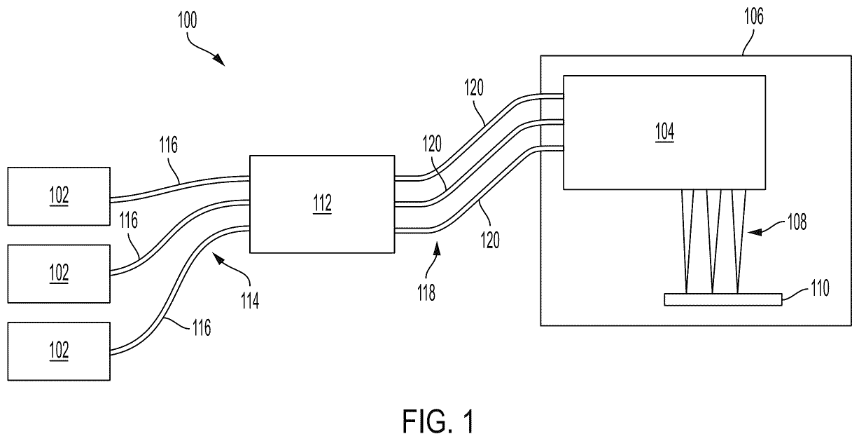

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course, other methods of connecting the laser energy sources 102 due to the optics assembly 104 are also contemplated.

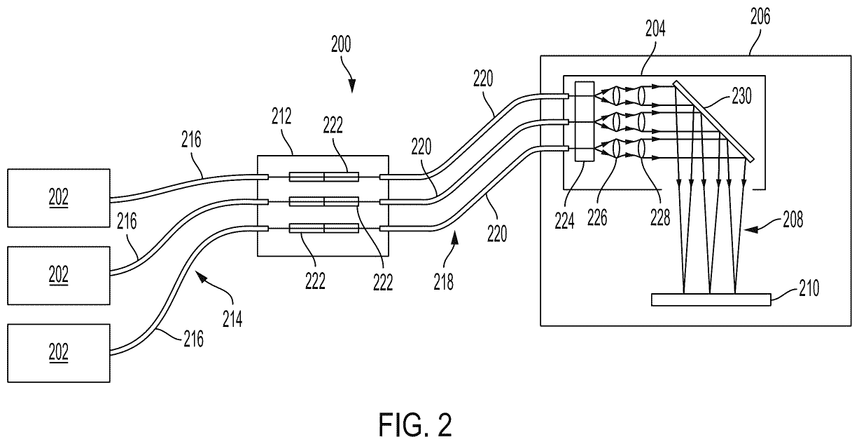

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, optical fibers 216 are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and 228 (which may be individual lenses, lens arrays, and/or combined macrolenses), mirrors 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

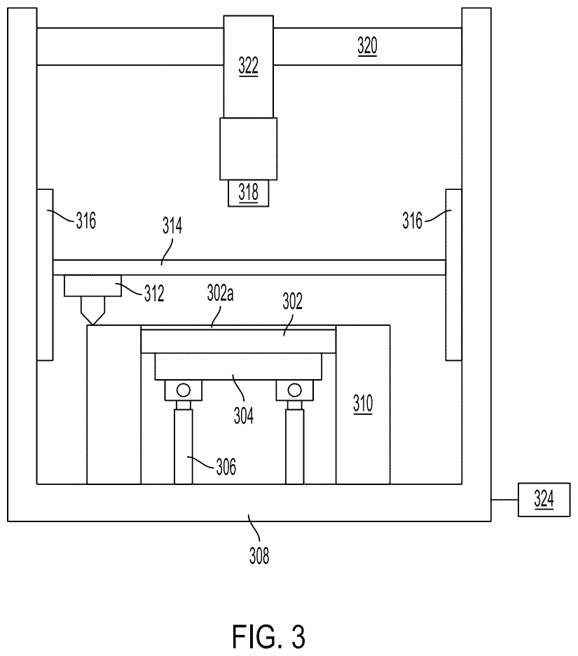

FIG. 3 depicts one embodiment of an additive manufacturing system at the beginning of a build process. The additive manufacturing system includes a build plate 302 mounted on a fixed plate 304, which is in turn mounted on one or more vertical supports 306 that attach to a base 308 of the additive manufacturing system. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate and contained within the shroud. The shroud may be supported on the base 308 or by any other appropriate portion of the system.

The additive manufacturing system may include a powder deposition system in the form of a recoater 312 that is mounted on a horizontal motion stage 314 that allows the recoater to be moved back and forth across either a portion, or entire, surface of the build plate 302. As the recoater traversers the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. To facilitate movement of the laser energy pixels across the build surface, the optics assembly may be configured to move in one, two, or any number of directions in a plane parallel to the build surface of the build plate. To provide this functionality, the optics assembly may be mounted on a gantry 320, or other actuated structure, that allows the optics unit to be scanned in plane parallel to the build surface of the build plate.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage 316 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

In addition to the above, in some embodiments, the depicted additive manufacturing system may include one or more controllers 324 that is operatively coupled to the various actively controlled components of the additive manufacturing system. For example, the one or more controllers may be operatively coupled to the one or more supports 306, recoater 312, optics assembly 318, the various motion stages, and/or any other appropriate component of the system. In some embodiments, the controller 324 may include one or more processors and associated non-transitory computer readable memory. The non-transitory computer readable memory may include processor executable instructions that when executed by the one or more processors cause the additive manufacturing system to perform any of the methods disclosed herein.

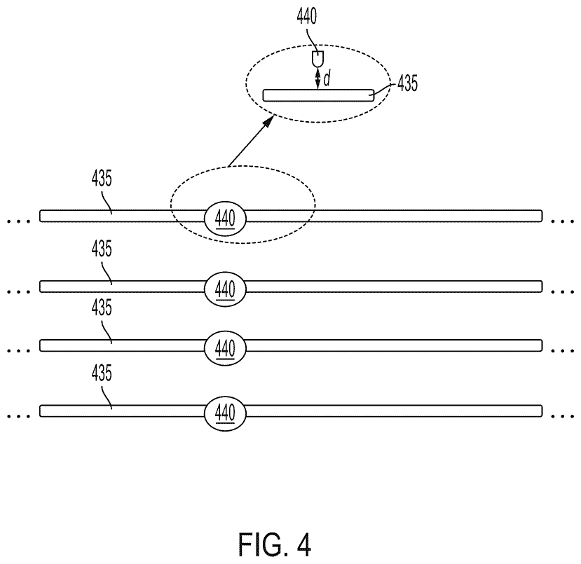

FIG. 4 shows photosensitive detectors 440 arranged in a one-to-one relationship with optical fibers 435 according to some embodiments. The optical fibers 435 shown in FIG. 4 may be among the first plurality of optical fibers 114 or the second plurality of optical fibers 118 and may be anywhere along the length of the optical fibers 116, 120 shown in FIG. 1 between the outputs of corresponding laser energy sources 102 and an input of the optics assembly 104. While four exemplary optical fibers 435 are shown in FIG. 4, one or any number of optical fibers 435 associated with respective laser energy sources 102 may be present. As shown, one photosensitive detector 440 is arranged in association with each optical fiber 435.

A top view of photosensitive detectors 440 above the optical fibers 118 is shown in FIG. 4 while the enhanced portion shows a side view. As the side view indicates, the photosensitive detectors 440 may not be in contact with the optical fibers 435. Instead, each photosensitive detector 440 may be spaced at a distance d away from the corresponding optical fiber 435 such that the photosensitive detector 400 may be configured to sense light emitted from the associated optical fiber 435. The distance d may be on the order of millimeters (e.g., less than 10 millimeters). While not shown in FIG. 4, each photosensitive detector 440 may provide a signal (e.g., indicating a current level) to one or more controllers 324 based on detection of light in a particular wavelength range. The signal from a given photosensitive detector 440 may indicate an intensity of light in the particular wavelength range that is detected in the corresponding optical fiber 435.

When the photosensitive detector 440 is selected to limit the particular wavelength range of light that it detects to at least some of the wavelengths of light emitted by the flash associated with a fiber fuse (e.g., wavelengths of red light or lower wavelengths), then the photosensitive detector 440 can act as a fiber fuse detector. For example, the flash associated with a fiber fuse may involve wavelengths of 400 to 700 nanometers, while exemplary embodiments of a photosensitive detector 440 may include a red light emitting diode (LED) that detects a wavelengths of 630 to 700 nanometers.

Based on the intensity of a fiber fuse, sensitivity of each of the photosensitive detectors 440, and proximity of the optical fibers 435 to each other, the fiber fuse through a given optical fiber 435 shown in FIG. 4 may be detected not only by the photosensitive detector 440 associated with the given optical fiber 435 but also by adjacent photosensitive detectors 440. Because the intensity of light detected by a photosensitive detector 440 directly corresponds to a magnitude of the current or voltage output by the photosensitive detector 440 to the one or more controllers 324, the given optical fiber 435 with the fiber fuse may be identified based on its associated photosensitive detector 440 having the highest magnitude output, even if other photosensitive detectors 440 also provide an output based on detection of the fiber fuse. This intensity-based triangulation may be implemented by the one or more controllers 324.

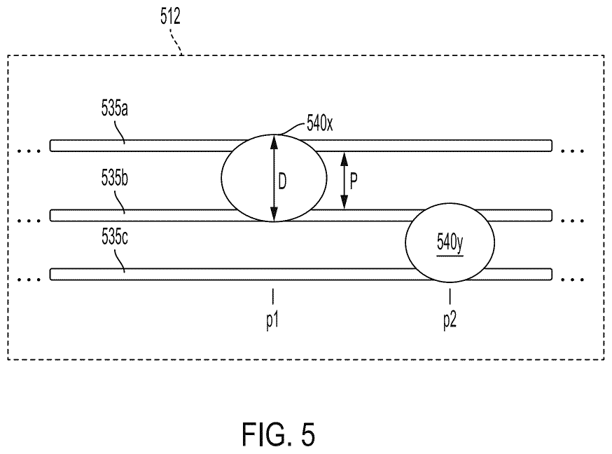

FIG. 5 shows photosensitive detectors 540 within an optical fiber connector 512 according to some embodiments. Three exemplary optical fibers 535a, 535b, 535c (generally referred to as 535) are shown within the exemplary optical fiber connector 512. As noted with reference to FIG. 4, one or any number of optical fibers 535 may be present and associated with respective laser energy sources 102. In addition, the optical fibers 535 may be on either side of the optical fiber connector 512 such that the optical fibers 535 may be among the first plurality of optical fibers 114 or the second plurality of optical fibers 118, as shown in FIG. 1.

The arrangement illustrated in FIG. 5 involves photosensitive detectors 540x, 540y (generally referred to as 540) with diameters D, or another appropriate transverse dimension, that exceed a pitch P of the optical fibers 535. This means that each photosensitive detector 540 can detect fiber fuse through more than one optical fiber 535. In the exemplary case shown in FIG. 5, each photosensitive detector 540 can detect a fiber fuse propagating through two different optical fibers 535, and fiber fuse through the center optical fiber 535 may be detected by both photosensitive detectors 540 but at different positions along the length of the optical fibers 535. Specifically, the photosensitive detector 540x would detect a fiber fuse through optical fibers 535a and 535b at a position p1, and the photosensitive detector 540y would detect a fiber fuse through optical fibers 535b and 535c at a different position p2 along the length of the optical fibers 535.

Because both photosensitive detectors 540 can detect fiber fuse through a common optical fiber 535b, a process of elimination may be used to identify which optical fiber 535 has fiber fuse-induced plasma propagating therethrough. That is, if both photosensitive detectors 540x and 540y detect fiber fuse at the two different positions p1 and p2, then the fiber fuse is known to be flowing through optical fiber 535b, because it is the only optical fiber that both photosensitive detectors 540x and 540y sense. However, if only photosensitive detector 540x detects a fiber fuse, then the fiber fuse-induced plasma is known to be propagating through optical fiber 535a. Similarly, if only photosensitive detector 540y detects a fiber fuse, then the fiber fuse-induced plasma is known to be propagating through optical fiber 535c. It should be understood that this process of elimination may be extended to additional photosensitive detectors 540 and optical fibers 535.

As noted with reference to FIG. 4, based on the sensitivity of the photosensitive detectors 540, proximity of the optical fibers 535, and intensity of a fiber fuse, both photosensitive detectors 540 may detect a fiber fuse even through optical fibers 535a and 535c, according to the exemplary arrangement and orientation shown in FIG. 5. As previously noted, an intensity-based triangulation may be used to identify the optical fiber 535 experiencing the fiber fuse. For example, a fiber fuse through the optical fiber 535c may be detected by the photosensitive detector 540y and also, at a lower intensity, by photosensitive detector 540x. While a process of elimination approach alone may suggest that the fiber fuse is through the optical fiber 535b, the higher intensity detected by photosensitive detector 540y may be used to correctly identify the optical fiber 535b as having the fiber fuse. Thus, a combination of a process of elimination and intensity-based triangulation may be used. Additionally, the temporal difference in detections by the two photosensitive detectors 540 may be used as a check on false alarms. That is, if, for example, the laser energy sources 102 are on the left, according to the arrangement and orientation shown in FIG. 5, then a fiber fuse would be expected to travel from right to left. Thus, detection of a fiber fuse by the photosensitive detector 540y prior to detection by the photosensitive detector 540x may suggest that the detections are not faulty or false alarms. This temporal verification process may also be used in alternate arrangements, as further discussed.

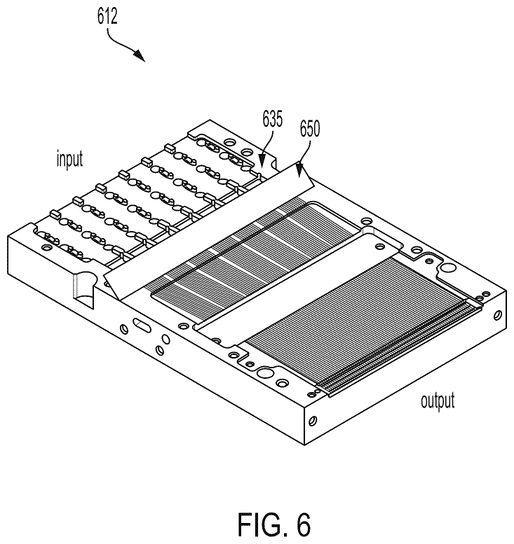

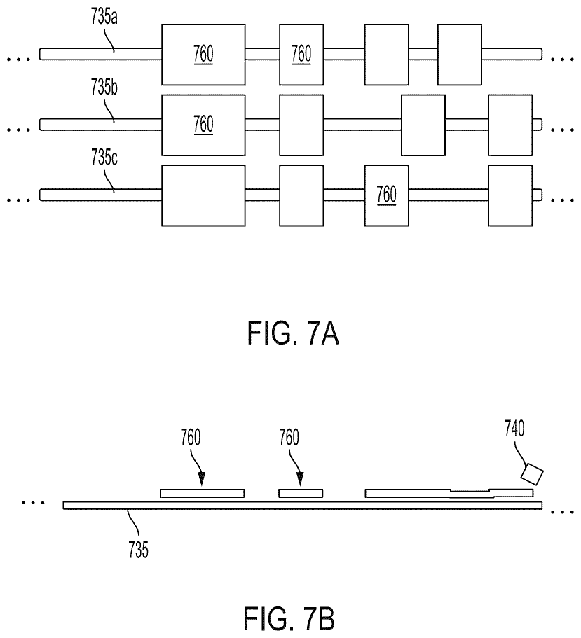

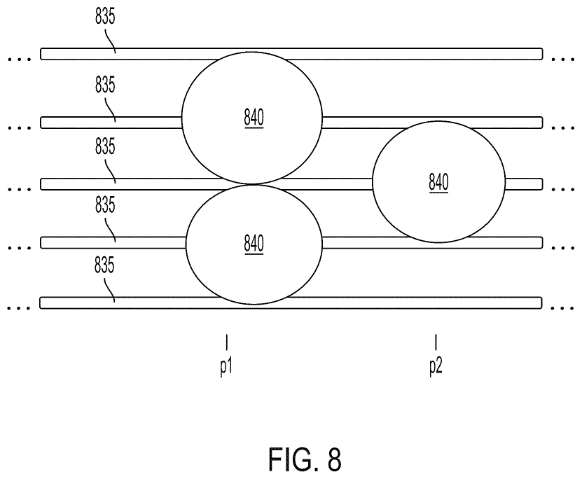

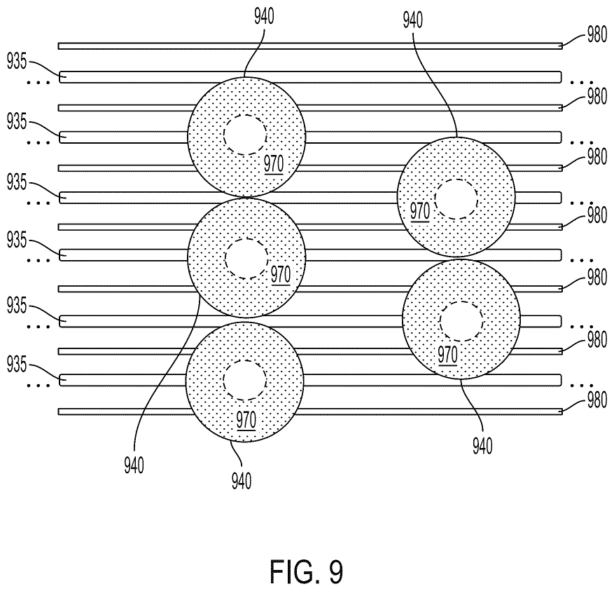

FIG. 6 shows a printed circuit board 650 that supports a plurality of photosensitive detectors according to some embodiments. The exemplary illustration of the printed circuit board 650 is supported adjacent to and/or mounted on an optical fiber holder 612 configured to position the separate optical fibers 635 in a desired arrangement (e.g., in predetermined longitudinal and lateral positions) within an overall optical fiber array. In addition, the exemplary arrangement of the printed circuit board 650 across optical fibers 635 and at a same position of all of the optical fibers 635, suggests that photosensitive detectors (on the side of the printed circuit board 650 that is not visible) are in an arrangement similar to that shown in FIG. 4. However, the printed circuit board 650 may be positioned anywhere along the length of the optical fibers 635 and may be sized and arranged such that any arrangement of photosensitive detectors is supported. For example, the printed circuit board may be sized to support the photosensitive detectors 540x and 540y shown in FIG. 5. Alternately, the printed circuit board 650 may support the photosensitive detector 740 (FIG. 7B) or photosensitive detectors 840 (FIG. 8) or 940 (FIG. 9).

While a particular optical fiber holder 612 for holding the optical fibers 635 in a desired configuration has been shown, it should be understood that any appropriate device and/or method of positioning the optical fibers 635 in a desired configuration and mounting one or more photosensitive detectors at any desired location along a length of the optical fibers 635 may be used as the disclosure is not so limited. Additionally, in yet another embodiment, the photosensitive detectors may be positioned on one or more separate supports other than a printed circuit board 650 as the disclosure is not limited to where or how the photosensitive detectors are positioned relative to the associated optical fibers 635.

FIG. 7A shows a top view of opaque masks 760 arranged relative to optical fibers 735 according to some embodiments. One or more photosensitive detectors 740, such as the one shown in FIG. 7B, are positioned with the opaque masks 760 disposed between the one or more photosensitive detectors 740 and at least a portion of the optical fibers 735a-735c. According to the arrangement, the opaque masks 760 block transmission of light caused by a fiber fuse propagating through one or more blocked portions of the optical fibers 735 from being detected by the one or more photosensitive detectors 740. Accordingly, each opaque mask 760 prevents detection, by any photosensitive detector 740, of the portion of the optical fiber 735 that it covers. Three exemplary optical fibers 735a, 735b, 735c (generally referred to as 735) are shown in FIG. 7A. When all the optical fibers 735 are monitored by the same photosensitive detector 740, as shown in FIG. 7B for the exemplary case, or, more generally, when any photosensitive detector 740 has more than one optical fiber 735 in its field of view, identifying which optical fiber 735 evidences fiber fuse-induced plasma propagation can be difficult. This may be especially true when the pitch of the optical fibers 735 is small (e.g., on the order of 0.5 to 1 millimeters).

In these cases, the pattern of placement of the opaque masks 760 may help identify the optical fiber 735 that has a fiber fuse. Specifically, the positions of a set of opaque masks 760 on a given optical fiber 735 differ from the positions of another set of opaque masks 760 on an adjacent optical fiber 735 by the position of at least one opaque mask 760. For example, in the exemplary arrangement shown in FIG. 7A, the positions of the opaque masks 760 arranged above optical fiber 735b and the positions of the opaque masks 760 arranged above the optical fiber 735c differ by the position of one of the opaque masks 760 (the second from the right). As a result, the pattern of detection of the bright light that signals the propagation of fiber fuse-induced plasma (i.e., the areas in which the bright white light is not detectable due to the opaque masks 760) is not identical but, instead, differs based on whether it flows through optical fiber 735b or optical fiber 735c. Similarly, the opaque masks 760 arranged above optical fiber 735a differ in their positions from the optical masks arranged above adjacent optical fiber 735b. As shown in FIG. 7A, the positions of the (right-most) two opaque masks 760 differ between the two optical fibers 735a, 735b. As a result, the pattern of visibility of the bright light resulting from fiber fuse-induced plasma propagation facilitates a determination of which of the optical fibers 735a, 735b has a fiber fusc.

FIG. 7B shows a side view of the opaque masks 760 in FIG. 7A along with a photosensitive detector 740. As previously noted, this side view illustrates that the opaque masks 760 are positioned between the optical fibers 735 and photosensitive detector 740 such that the opaque masks 760 obscure the portion of the optical fibers 735 above which they are positioned from the photosensitive detector 740. Thus, for a given optical fiber 735, the pattern of arrangement of opaque masks 760 above the given optical fiber 735 determines the pattern of detection of the bright white light indicating fiber fuse-induced plasma propagation through the given optical fiber 735 by the photosensitive detector 740. As discussed with reference to FIG. 7A, this pattern of detection and, more specifically, the difference in pattern of detection among adjacent optical fibers 735 may be used to identify which optical fiber 735 has a fiber fuse.

In the above embodiments, multiple opaque masks 760 associated with each optical fiber 735 are arranged in a specific pattern that may be used to determine which optical fiber 735 is experiencing a fiber fuse event. However, according to alternate embodiments, other arrangements of opaque masks 760 may be used to mask one or more portions of the optical fibers 735 to provide a desired field of view for the one or more associated photosensitive detectors 740. For example, in another embodiment, the masks may correspond to one or more masks with a plurality of pin holes, or other arrangement of holes, that limit the detection of a fiber fuse event to a single photosensitive detector 740. Separately, in another embodiment, the masks may limit the detection of a fiber fuse event in a specific optical fiber 735 to be located in a specific portion of a field of view of a photosensitive detector 740 to determine which optical fiber 735 is experiencing a fiber fuse. Thus, the disclosed masks may be arranged in any appropriate manner to facilitate the detection and identification of a fiber fuse event in a specific optical fiber 735 of the plurality of optical fibers 735. The intensity-based triangulation and temporal verification discussed with reference to FIGS. 4 and 5 may be employed, as well.

FIG. 8 shows an arrangement of photosensitive detectors 840 with diameters greater than a pitch of optical fibers 835 according to some embodiments. As FIG. 8 illustrates, one group of one or more photosensitive detectors 840 may be at one position (e.g., position p1) while another group of one or more photosensitive detectors 840 may be at another position (e.g., position p2) along the length of the optical fibers 835. This arrangement is similar to the one shown in FIG. 5 within the optical fiber connector 512. As discussed with reference to FIG. 5, a process of elimination may be used to determine which optical fiber 735 includes a fiber fuse based on the overlapping arrangement of photosensitive detectors 840. Intensity-based triangulation may additionally be used, as discussed with reference to FIG. 5, and temporal detection may be used for verification.

Unlike the arrangement in FIG. 5, the arrangement in FIG. 8 includes photosensitive detectors 840 with diameters, or other transverse dimension, that are large enough (or optical fibers 835 whose pitch is small enough) such that each photosensitive detector 840 can detect fiber fuse in three different optical fibers 835. Thus, the process of elimination used by the one or more controllers 324 accounts for the fact that a given photosensitive detector 840 at position p1 will detect fiber fuse in the same two optical fibers 835 as an photosensitive detector 840 at position p2, but one of those two optical fibers 835 will also be in the field of view of a second photosensitive detector 840 at position p1. Thus, fiber fuse detected by all three photosensitive detectors 840 can be attributed to the optical fiber 835 detected by all three photosensitive detectors 840 and distinguished from fiber fuse detected by only the given photosensitive detector 840 at position p1 and the photosensitive detector 840 at position p2.

FIG. 9 shows an arrangement of photosensitive detectors 940 including masks 970 to limit field of view and optical fibers 935 separated by baffles 980 according to some embodiments. As FIG. 9 illustrates, the diameter of the photosensitive detectors 940 exceeds the pitch of the optical fibers 935. However, masks 970 are used to limit the field of view of each of the photosensitive detectors 940 to the interior portion (shown in white). In addition, each of the optical fibers 935 has baffles 980 on either side. The baffles 980 are parallel with the optical fibers 935, as shown in FIG. 9. Based on the masks 970 and the baffles 980, each photosensitive detector 940 detects fiber fused-induced plasma propagation through only one optical fiber 935. Thus, although the arrangement in FIG. 9 may look similar to that of FIG. 8 at first glance, it is functionally similar to the arrangement in FIG. 4 where a single photosensitive detector 940 may be associated with a single corresponding optical fiber 935, though this arrangement may offer an improved signal to noise ratio for detecting a fiber fuse event given the reduced transmission of light from adjacent optical fibers 935. Further, based on the masks 970 and baffles 980, intensity-based triangulation may be unnecessary. However, temporal verification may additionally be employed with embodiments according to FIG. 9.

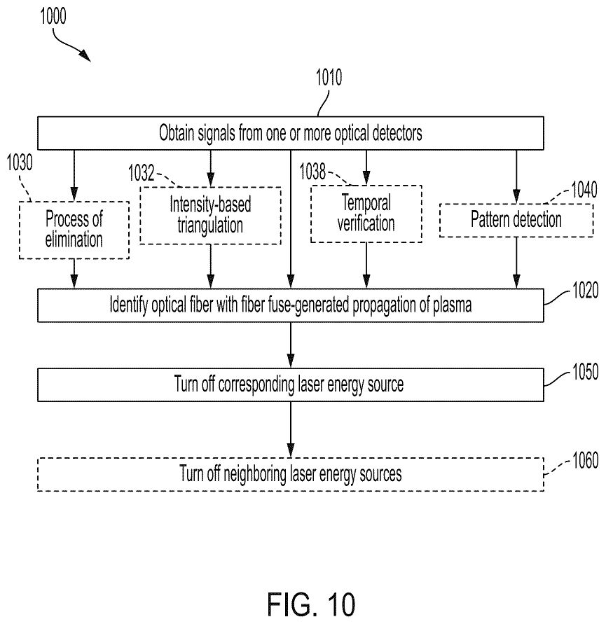

FIG. 10 is a process flow of a method 1000 for additive manufacturing including detecting fiber fuse according to some embodiments. The processes may be implemented by one or more of the controllers 324. At 1010, the processes include obtaining signals from one or more photosensitive detectors 440, 540, 740, 840, 940. The signals indicate an intensity of detected light in the wavelength range in which the photosensitive detectors 440, 540, 740, 840, 940 are sensitive. At 1020, the signals from one or more photosensitive detectors 440, 540, 740, 840, 940 may be used to identify an optical fiber 435, 535, 635, 735, 835, 935 with fiber fuse-generated plasma propagating through it. As indicated, a process of elimination, at 1030, or patter detection, at 1040, may be needed to perform the identification at 1020 in some embodiments where multiple optical fibers are associated with a given photosensitive detector. As also indicated, intensity-based triangulation, at 1032, and/or temporal verification, at 1038, may additionally be performed as part of the identification at 1020. The process of elimination (at 1030) is detailed with reference to FIG. 5, and the pattern detection (at 1040) is detailed with reference to FIG. 7. Intensity-based triangulation (at 1032) is discussed with reference to FIGS. 4 and 5, and temporal verification (at 1038) is discussed with reference to FIG. 5. Once fiber fuse is detected in a given optical fiber 435, 535, 635, 735, 835, 935, the method 1000 includes turning off a laser energy source 102 that corresponds to the given optical fiber 435, 535, 635, 735, 835, 935. Optionally, the method 1000 may also include turning off neighboring laser energy sources 102.

The above method may be implemented by one or more controllers including at least one processor operatively coupled to the various controllable portions of an additive manufacturing system as disclosed herein. The method may be embodied as computer readable instructions stored on non-transitory computer readable memory associated with the at least one processor such that when executed by the at least one processor the additive manufacturing system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system comprising:
a build surface configured to support a precursor material;
one or more laser energy sources;
an optics assembly configured to direct laser energy from the one or more laser energy sources toward the build surface to form a corresponding one or more laser pixels on the build surface to selectively fuse the precursor material on the build surface;
one or more optical fibers optically coupling the one or more laser energy sources and the optics assembly;
one or more photosensitive detectors arranged along a length of the one or more optical fibers between an output of the one or more laser energy sources and an input of the optics assembly, wherein:
each photosensitive detector among the one or more photosensitive detectors is in a contact-less arrangement with one or more of the two or more optical fibers, and
each photosensitive detector among the one or more photosensitive detectors is configured to detect fiber fuse-generated propagation of plasma through the one or more optical fibers; and
one or more processors arranged to receive signals from the one or more photosensitive detectors and to control operation of the one or more laser energy sources based at least in part on the signals.

2. The additive manufacturing system of claim 1, wherein the one or more processors are configured to turn off a laser energy source of the one or more laser energy sources in which the fiber fuse-generated propagation of plasma is detected.

3. The additive manufacturing system of claim 1, wherein the one or more photosensitive detectors includes a plurality of photosensitive detectors, the one or more laser energy sources includes a plurality of laser energy sources, the one or more optical fibers includes a plurality of optical fibers, and each of the plurality of photosensitive detectors is arranged to detect the fiber fuse-generated propagation of plasma through a respective one of the plurality of optical fibers.

4. The additive manufacturing system of claim 1, wherein the one or more photosensitive detectors are arranged within an optical fiber connector through which the one or more optical fibers extend between the one or more laser energy sources and the optics assembly.

5. The additive manufacturing system of claim 1, wherein the one or more photosensitive detectors are arranged on a printed circuit board.

6. The additive manufacturing system of claim 1, wherein
the one or more optical fibers includes a plurality of optical fibers, and
the system further comprises a plurality of opaque masks arranged between each of the plurality of optical fibers and the one or more photosensitive detectors, wherein
a position, along the length of the plurality of optical fibers, of at least one of the plurality of opaque masks of adjacent ones of the plurality of optical fibers is different, and
the one or more processors are configured to identify one of the plurality of optical fibers as including the fiber fuse-generated propagation of plasma based on a pattern of visibility of the fiber fuse-generated propagation of plasma matching positions of the plurality of opaque masks arranged on the one of the plurality of optical fibers.

7. The additive manufacturing system of claim 1, wherein the one or more photosensitive detectors includes a plurality of photosensitive detectors, and the plurality of photosensitive detectors includes a first group of one or more photosensitive detectors located at a first position along the length of the one or more optical fibers and a second group of photosensitive detectors located at a second position, different than the first position, along the length of the one or more optical fibers.

8. The additive manufacturing system of claim 1, wherein the one of more optical fibers includes a plurality of optical fibers, the one or more photosensitive detectors includes a plurality of photosensitive detectors, and each of the plurality of photosensitive detectors is arranged to detect plasma resulting from the fiber fuse-generated propagation of the plasma through two or more of the plurality of optical fibers.

9. The additive manufacturing system of claim 8, wherein the one or more processors are configured to use a process of elimination based on the signals from at least a first photosensitive detector and a second photosensitive detector among the plurality of photosensitive detectors to identify one of the plurality of optical fibers as including the fiber fuse-generated propagation of plasma.

10. The additive manufacturing system of claim 9, wherein the one or more processors are configured to use intensity-based triangulation to confirm the one of the plurality of optical fibers as including the fiber fuse-generated propagation of plasma based on intensity of light emitted by the plasma being higher at whichever among the first photosensitive detector and the second photosensitive detector is closer to the one of the plurality of optical fibers.

11. The additive manufacturing system of claim 9, wherein the one or more processors are configured to implement temporal verification based on the fiber fuse-generated propagation of plasma being toward the one or more laser energy sources to verify that whichever among the first photosensitive detector and the second photosensitive detector is farthest from the one or more laser energy sources detects the plasma first.

12. The additive manufacturing system of claim 1, wherein the one of more optical fibers includes a plurality of optical fibers, the one or more photosensitive detectors includes a plurality of photosensitive detectors, each of the plurality of photosensitive detectors has a diameter greater than a pitch of the plurality of optical fibers, and the system further comprises an opaque mask over a portion of each of the plurality of photosensitive detectors and baffles between adjacent ones of the plurality of optical fibers such that each of the plurality of photosensitive detectors detects the fiber fuse-generated propagation of plasma in only one of the plurality of optical fibers.

13. A method for additive manufacturing comprising:
controlling, using one or more processors, transmission of laser energy from one or more laser energy sources through an optics assembly, via one or more optical fibers optically coupling the one or more laser energy sources and the optics assembly, toward a build surface to expose a layer of material on the build surface to the laser energy to melt at least a portion of the layer of material due to exposure of the portion to the laser energy;
obtaining, using any of the one or more processors, signals from one or more photosensitive detectors in contact-less arrangement with the one or more of the one or more optical fibers along a length of the one or more optical fibers between an output of the one or more laser energy sources and an input of the optics assembly, wherein the signals indicate a fiber fuse-generated propagation of plasma through the one or more optical fibers; and
controlling, using any of the one or more processors, operation of the one or more laser energy sources based at least in part on the signals.

14. The method of claim 13, wherein the one or more laser energy sources includes a plurality of laser energy sources, and the controlling the operation includes turning off one or more of the plurality of laser energy sources based on the fiber fuse-generated propagation of plasma being detected in one of the one or more of the plurality of laser energy sources.

15. The method of claim 13, wherein the one or more photosensitive detectors includes a plurality of photosensitive detectors, the one or more laser energy sources includes a plurality of laser energy sources, the one or more optical fibers includes a plurality of optical fibers corresponding with a respective one of the plurality of laser energy sources, each of the plurality of photosensitive detectors is arranged to detect the fiber fuse-generated propagation of plasma through a respective one of the plurality of optical fibers associated with the respective one of the plurality of laser energy sources, and
the controlling the operation includes turning off a laser energy source among the plurality of laser energy sources based on the signal from a photosensitive detector among the plurality of photosensitive detectors indicating the fiber fuse-generated propagation of plasma in an optical fiber among the plurality of optical fibers corresponding with the laser energy source among the plurality of laser energy sources.

16. The method of claim 13, wherein the one or more laser energy sources includes a plurality of laser energy sources, the one or more optical fibers includes a plurality of optical fibers corresponding with a respective one of the plurality of laser energy sources, a plurality of opaque masks are arranged between each of the plurality of optical fibers and the one or more photosensitive detectors with a location, along the length of the plurality of optical fibers, of at least one of the plurality of opaque masks of adjacent ones of the plurality of optical fibers being different, each of the one or more photosensitive detectors is arranged to detect the fiber fuse-generated propagation of plasma through two or more of the plurality of optical fibers, and the method further comprises:
identifying an optical fiber among the plurality of optical fibers with the fiber fuse-generated propagation of plasma based on a pattern of detection of the fiber fuse-generated propagation of plasma along the optical fiber defined by the plurality of opaque masks arranged relative to the optical fiber, wherein
the controlling the operation includes turning off a laser energy source among the plurality of laser energy sources corresponding with the optical fiber.

17. The method of claim 13, wherein the one or more laser energy sources includes a plurality of laser energy sources, the one or more optical fibers includes a plurality of optical fibers corresponding with a respective one of the plurality of laser energy sources, the one or more photosensitive detectors includes a plurality of photosensitive detectors, and the method further comprises:
identifying an optical fiber among the plurality of optical fibers with the fiber fuse-generated propagation of plasma includes using a process of elimination based on the signals from at least a first photosensitive detector and a second photosensitive detector among the plurality of photosensitive detectors, wherein
the controlling the operation includes turning off a laser energy source among the plurality of laser energy sources corresponding with the optical fiber.

18. The method of claim 17, further comprising using intensity-based triangulation to confirm the one of the plurality of optical fibers as including the fiber fuse-generated propagation of plasma based on intensity of light emitted by the plasma being higher at whichever among the first photosensitive detector and the second photosensitive detector is closer to the one of the plurality of optical fibers.

19. The method of claim 17, further comprising implementing temporal verification based on the fiber fuse-generated propagation of plasma being toward the one or more laser energy sources to verify that whichever among the first photosensitive detector and the second photosensitive detector is farthest from the one or more laser energy sources detects the plasma first.

20. The method of claim 13, further comprising fusing the at least a portion of the layer of material with the laser energy to form one or more parts on the build surface.

21. A part manufactured using the method of claim 20.

22. A non-transitory computer-readable medium storing instructions that, when processed by one or more processors, cause the one or more processors to implement a method for additive manufacturing, the method comprising:
controlling transmission of laser energy from one or more laser energy sources through an optics assembly, via one or more optical fibers optically coupling the one or more laser energy sources and the optics assembly, toward a build surface to expose a layer of material on the build surface to the laser energy to melt at least a portion of the layer of material due to exposure of the portion to the laser energy;
obtaining signals from one or more photosensitive detectors in contact-less arrangement with the one or more of the one or more optical fibers along a length of the one or more optical fibers between an output of the one or more laser energy sources and an input of the optics assembly, wherein the signals indicate a fiber fuse-generated propagation of plasma through the one or more optical fibers; and
controlling operation of the one or more laser energy sources based at least in part on the signals.

23. The non-transitory computer-readable medium of claim 22, wherein the one or more laser energy sources includes a plurality of laser energy sources, and the controlling the operation includes turning off one or more of the plurality of laser energy sources based on the fiber fuse-generated propagation of plasma being detected in one of the one or more of the plurality of laser energy sources.

24. The non-transitory computer-readable medium of claim 22, wherein the one or more photosensitive detectors includes a plurality of photosensitive detectors, the one or more laser energy sources includes a plurality of laser energy sources, the one or more optical fibers includes a plurality of optical fibers corresponding with a respective one of the plurality of laser energy sources, each of the plurality of photosensitive detectors is arranged to detect the fiber fuse-generated propagation of plasma through a respective one of the plurality of optical fibers associated with the respective one of the plurality of laser energy sources, and
the controlling the operation includes turning off a laser energy source among the plurality of laser energy sources based on the signal from a photosensitive detector among the plurality of photosensitive detectors indicating the fiber fuse-generated propagation of plasma in an optical fiber among the plurality of optical fibers corresponding with the laser energy source among the plurality of laser energy sources.

25. The non-transitory computer-readable medium of claim 22, wherein the one or more laser energy sources includes a plurality of laser energy sources, the one or more optical fibers includes a plurality of optical fibers corresponding with a respective one of the plurality of laser energy sources, a plurality of opaque masks are arranged between each of the plurality of optical fibers and the one or more photosensitive detectors with a location, along the length of the plurality of optical fibers, of at least one of the plurality of opaque masks of adjacent ones of the plurality of optical fibers being different, each of the one or more photosensitive detectors is arranged to detect the fiber fuse-generated propagation of plasma through two or more of the plurality of optical fibers, and the method further comprises:
identifying an optical fiber among the plurality of optical fibers with the fiber fuse-generated propagation of plasma based on a pattern of detection of the fiber fuse-generated propagation of plasma along the optical fiber defined by the plurality of opaque masks arranged relative to the optical fiber, wherein
the controlling the operation includes turning off a laser energy source among the plurality of laser energy sources corresponding with the optical fiber.

26. The non-transitory computer-readable medium of claim 22, wherein the one or more laser energy sources includes a plurality of laser energy sources, the one or more optical fibers includes a plurality of optical fibers corresponding with a respective one of the plurality of laser energy sources, the one or more photosensitive detectors includes a plurality of photosensitive detectors, and the method further comprises
identifying an optical fiber among the plurality of optical fibers with the fiber fuse-generated propagation of plasma includes using a process of elimination based on the signals from at least a first photosensitive detector and a second photosensitive detector among the plurality of photosensitive detectors, wherein
the controlling the operation includes turning off a laser energy source among the plurality of laser energy sources corresponding with the optical fiber.

27. The non-transitory computer-readable medium of claim 26, further comprising using intensity-based triangulation to confirm the one of the plurality of optical fibers as including the fiber fuse-generated propagation of plasma based on intensity of light emitted by the plasma being higher at whichever among the first photosensitive detector and the second photosensitive detector is closer to the one of the plurality of optical fibers.

28. The non-transitory computer-readable medium of claim 27, further comprising implementing temporal verification based on the fiber fuse-generated propagation of plasma being toward the one or more laser energy sources to verify that whichever among the first photosensitive detector and the second photosensitive detector is farthest from the one or more laser energy sources detects the plasma first.
